(19) United States
(12) Patent Application Publication
(10) Pub. No.: US 2016/0355668 A1
(43) Pub. Date: Dec. 8, 2016

(54) MODIFIED RELEASE AGENT FOR IMPROVED POLYCARBONATE STABILITY

(71) Applicant: SAUDI BASIC INDUSTRIES CORPORATION, Riyadh (SA)

(72) Inventor: Carlos Godinez Seoane, Cartagena (ES)

(21) Appl. No.: 15/110,843

(22) PCT Filed: Dec. 29, 2014
(86) PCT No.: PCT/IB2014/067392

§ 371 Date: Jul. 11, 2016

Related U.S. Application Data
(60) Provisional application No. 61/923,935, filed on Jan. 6, 2014.

(51) Int. Cl. C08K 5/42; C08K 3/22; C08K 5/092; C08K 3/08; C08L 69/00; C08K 5/09

(52) U.S. Cl. CPC C08K 5/42; C08L 69/00; C08K 5/09; C08K 5/092; C08K 3/08; C08K 3/22; C08K 2003/0818; C08K 2003/0825

(57) ABSTRACT

The presently disclosed subject matter relates to polycarbonate compositions and methods of manufacturing the polycarbonate compositions. In one exemplary embodiment, a polycarbonate composition of the present disclosure includes one or more polycarbonate polymers, one or more catalysts and one or more bi-functional additive agents, wherein the bi-functional additive has quenching and release activities.

### TECHNICAL FIELD

The presently disclosed subject matter relates to polycarbonate compositions and methods for generating polycarbonate compositions.

### BACKGROUND

Aromatic polycarbonate compounds are thermoplastic materials that are useful in a wide range of applications because of their physical and chemical properties, including strength, impact resistance, heat resistance, optical clarity and physiological inertness. Polycarbonates are used in the fabrication of optical media and film, automotive applications, medical products and electrical products. Polycarbonate compositions can be prepared by a melt transesterification reaction of carbonic acid diesters, such as diphenyl carbonate, and aromatic dihydroxy compounds, such as bisphenol A, in the presence of an alkaline catalyst.

This transesterification process allows the manufacture of polycarbonates at a lower cost compared to other methods for generating polycarbonates. However, the presence of residual alkaline catalyst in the polycarbonate composition results in a detrimental effect on the quality of the product, leading to poor color, molecular weight, stability and mold release properties. To reduce the detrimental effects of the residual catalyst, additives are added to the polycarbonate composition to quench the reactive groups present on the alkaline catalyst. These additives are known as “quenchers.” In addition to quenching additives, mold release agents are added to polycarbonate compositions to impart mold release properties. Mold release agents are added to polycarbonate compositions to prevent adhesion of the polycarbonate to molds during the manufacture of molded polycarbonate-based products.

Quencher and release agents for the production of polycarbonates are known in the art. For example, U.S. Pat. No. 6,221,556 B1, Japanese Patent Publication No. 2001-329158 and European Patent No. 1970410 B1 disclose fatty acid esters as mold release agents for use in polycarbonate compositions. European Patent Application No. 2404969 A1 discloses acid compounds as quenchers for use in polycarbonates compositions. Currently, individual quenching compounds and release compounds are added separately to improve the properties of polycarbonate compositions. Thus, there remains a continued need in the art for an additive agent that performs both release and quenching activities.

### SUMMARY

The presently disclosed subject matter relates to polycarbonate compositions. In particular, the presently disclosed subject matter provides for polycarbonate compositions that include a bi-functional additive agent and methods for manufacturing the polycarbonate compositions.

A polycarbonate composition, comprises: one or more polycarbonate polymers, one or more catalysts and one or more one bi-functional additive agents, wherein the bi-functional additive agent has quenching and release activities.

A method for generating a polycarbonate composition, comprising: introducing a feedstream comprising an aromatic dihydroxy compound and carbonic acid diester into a reactor in the presence of one or more catalysts to generate one or more polycarbonate polymers; and adding one or more bi-functional additive agents that has quenching and release activities to the one or more polycarbonate polymers to generate a polycarbonate composition.

A method for generating a polycarbonate composition, comprising: producing one or more polycarbonate polymers in the presence of one or more catalysts; and adding one or more bi-functional additive agents that has quenching and release activities to the one or more polycarbonate polymers to generate a polycarbonate composition.

These and other features and characteristics are more particularly described below.

### BRIEF DESCRIPTION OF THE FIGURES

The following is a brief description of the drawings wherein like elements are numbered alike and which are presented for the purposes of illustrating the exemplary embodiments disclosed herein and not for the purposes of limiting the same.

FIG. 1 depicts bi-functional additive agents according to one exemplary embodiment of the disclosed subject matter.

FIG. 2 depicts a method for generating a polycarbonate composition according to one exemplary embodiment of the disclosed subject matter.

### DETAILED DESCRIPTION

The presently disclosed subject matter relates to polycarbonate compositions. In particular, the presently disclosed subject matter provides for polycarbonate compositions that include a bi-functional additive agent that has quenching and release activities. The present disclosure further provides for methods for manufacturing the polycarbonate compositions.

The bi-functional additive agent functions to quench the catalyst that is present in polycarbonate compositions of the presently disclosed subject matter. The bi-functional additive agent further functions as a mold release agent to minimize the adhesion of the polycarbonate composition to the surface of a mold during the production of molded polycarbonate-based products. The addition of a bi-functional agent of the present disclosure results in a polycarbonate composition with a more consistent molecular weight and higher thermal, hydrolytical and ultraviolet light stability.

In certain embodiments, the polycarbonate composition includes one or more polycarbonate polymers, one or more catalysts and one or more bi-functional additive agents, wherein the bi-functional additive has quenching and release activities. In certain embodiments, the polycarbonate composition can be generated from a melt polycondensation reaction of an aromatic dihydroxy compound and a carbonic acid diester in the presence of a catalyst. In certain embodiments, the aromatic dihydroxy compound is bisphenol-A. In certain embodiments, the carbonic acid diester is diphenyl carbonate.

In certain embodiments, the bi-functional additive agent includes a carboxylic acid derivative of glycerol monostearate, a sulphonic acid derivative of glycerol monostearate, a carboxylic acid derivative of pentaerythritol tristearate, a sulphonic acid derivative of pentaerythritol tristearate and combinations thereof. In certain embodiments, the bi-functional additive agent is present in the polycarbonate composition at an amount of about 1 to about 10 parts per million (ppm). In certain embodiments, the bi-functional additive agent is present in the polycarbonate composition at an amount of about 4 to about 6 ppm.

In certain embodiments, the catalyst present in the polycarbonate composition includes an alkali metal compounds, alkaline earth metal compound and combinations thereof. For example, the catalyst can include potassium hydroxide.

In certain embodiments, the polycarbonate composition can further include one or more mold release agents. For example, the one or more mold release agents can include glycerol monostearate, pentaerythritol tetrastearate and combinations thereof. In certain embodiments, the polycarbonate composition can further include one or more additives including, but not limited to, heat stabilizers, stabilization adjuvants, plasticizers, antioxidants, photostabilizers, nucleating agents, heavy metal-inactivating agents, flame retardants, lubricants, antistatic agents, colorants, ultraviolet absorbers and combinations thereof.

The subject matter further provides for methods of manufacturing the disclosed polycarbonate compositions. In certain embodiments, the method for generating a polycarbonate composition, includes: introducing a feedstream comprising an aromatic dihydroxy compound and carbonic acid diester into a reactor in the presence of one or more catalysts to generate one or more polycarbonate polymers and adding one or more bi-functional additive agents that has quenching and release activities to the one or more polycarbonate polymers to generate a polycarbonate composition. In certain embodiments, the aromatic dihydroxy compound is bisphenol-A. In certain embodiments, the carbonic acid diester is diphenyl carbonate. In certain embodiments, the method can further include transporting the one or more polycarbonate polymers to an extruder to form an extrudate, wherein the one or more bi-functional additive agents is added to the polycarbonate polymers in the extruder.

The term “about” or “approximately” means within an acceptable error range for the particular value as determined by one of ordinary skill in the art, which will depend in part on how the value is measure or determine, i.e., the limitations of the measurement system. For example, “about” can mean a range of up to 20%, up to 10%, up to 5%, and or up to 1% of a given value.

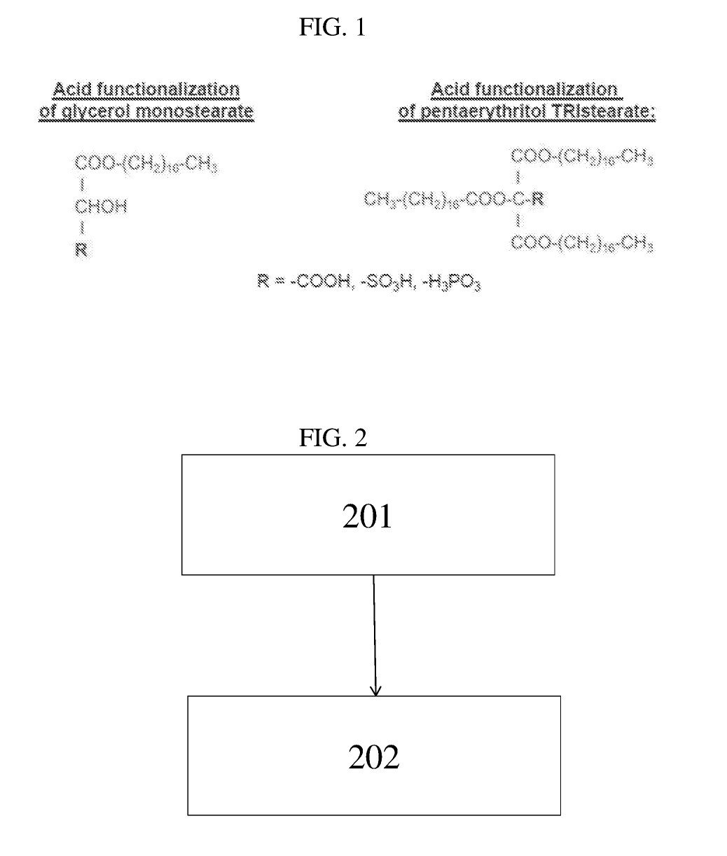

The polycarbonate compositions of the presently disclosed subject matter includes one or more polycarbonate polymers and one or more catalysts. In certain embodiments, the polycarbonate composition can further include one or more bi-functional additive agents. For the purpose of illustration and not limitation, FIG. 1 shows bi-functional additive agents in accordance with one embodiment of the disclosed subject matter. As shown in FIG. 1, the bi-functional additive agent can include an acid derivative of glycerol monostearate and pentaerythritol tristearate. In certain embodiments, the bi-functional additive agent can be an acid derivative of saturated fatty acid esters of pentaerythritol and glycerol containing from about 16 to about 26 carbon atoms. For example, but not by way of limitation, the bi-functional additive agent can be a pentaerythritol or a glycerol compound containing about 16 to about 26 carbon atoms substituted with a carboxylic acid group (—COOH), sulfonic acid group (—SO₃H) or a phosphonic acid group (H₃PO₃).

The bi-functional additive agents according to the presently disclosed subject matter can also include phosphonic acid, carboxylic acid and sulphonic acid derivatives of pentaerythritol tripalmitate, pentaerythritol triarachidate, pentaerythritol tribehenate, pentaerythritol trilignocerate, pentaerythritol tricerotate, glycerol distearate, glyceroldipalmitate, glycerol diarachidate, glycerol dibehenate, glycerol dilignocerate, glycerol dicerotate, glycerol monopalmitate, glycerol monoarachidate, glycerol monobehenate, glycerol monolignocerate and glycerol monocerotate.

In certain embodiments, the bi-functional additive agent can include a carboxylic acid derivative of glycerol monostearate, a sulphonic acid derivative of glycerol monostearate, a carboxylic acid derivative of pentaerythritol tristearate, a sulphonic acid derivative of pentaerythritol tristearate and combinations thereof. In certain embodiments, a polycarbonate composition according to the presently disclosed subject matter can include a carboxylic acid derivative of glycerol monostearate.

The amount of bi-functional additive agent present within the polycarbonate composition can be any amount which is sufficient to quench the reactive groups on the catalyst and improve the stability of the polycarbonate composition. In certain embodiments, the polycarbonate composition can include one or more bi-functional additive agents in the amount of about 1 to about 10 parts per million (ppm). For example, a polycarbonate composition can include one or more bi-functional additive agents in the amount of about 1 to about 9 ppm, of about 1 to about 8 ppm, of about 1 to about 7 ppm, of about 1 to about 6 ppm, of about 1 to about 5 ppm, of about 1 to about 4 ppm, of about 1 to about 3 ppm, of about 1 to about 2 ppm, of about 2 to about 10 ppm, of about 3 to about 10 ppm, of about 4 to about 10 ppm, of about 5 to about 10 ppm, of about 6 to about 10 ppm, of about 7 to about 10 ppm, of about 8 to about 10 ppm or of about 9 to about 10 ppm. In certain embodiments, the polycarbonate composition can include one or more bi-functional additive agents in the amount of about 4 to about 6 ppm.

The presently disclosed bi-functional additive agents can be synthesized using various reaction schemes known in the art. In certain embodiments, the bi-functional additive agents of the presently disclosed subject matter can be synthesized by the oxidation of the primary hydroxyl group of a pentaerythritol or a glycerol compound containing about 16 to about 26 carbon atoms using potassium permanganate (KMnO₄) in an acetic acid solution at ambient temperature. Additional examples of solutions that can be used to oxide a pentaerythritol or a glycerol compound to synthesize a bi-functional additive agent of the presently disclosed subject matter include, but are not limited to, chromium trioxide in aqueous sulfuric acid, ruthenium tetroxide, pyridinium dichromate in dimethylformamide and oxygen in a platinum solution. In certain embodiments, this synthesis process can result in a yield range of about 60% to about 95%.

The one or more polycarbonate polymers present within the polycarbonate composition can be of any molecular weight. For example, but not by way of limitation, the average molecular weight of the polycarbonate polymer can be about 5,000 to about 40,000 grams per mol (g/mol). The polycarbonate polymer present within the polycarbonate composition can also be of any structure. For example, the one or more polycarbonate polymers can include linear polycarbonate polymers, branched polycarbonate polymers, polyester carbonate polymers and combinations thereof. In certain embodiments, the polycarbonate composition can contain polycarbonate polymers in the amount of about 95 weight % to about 99.9 weight %. For example, the polycarbonate composition can contain polycarbonate polymers in an amount greater than or equal to about 95 weight %, greater than or equal to about 96 weight %, greater than or equal to about 97 weight %, greater than or equal to about 98 weight %, greater than or equal to about 99 weight %, greater than or equal to about 99.1 weight %, greater than or equal to about 99.5 weight %, greater than or equal to about 99.6 weight %, greater than or equal to about 99.7 weight %, greater than or equal to about 99.8 weight % or greater than or equal to about 99.9 weight %. In certain embodiments, the polycarbonate composition can contain polycarbonate polymers in an amount greater than or equal to about 99.9 weight %.

The one or more polycarbonate polymers present in the polycarbonate composition of the presently disclosed subject matter can be prepared using various polymerization reactions. For example, the polycarbonate can be generated from a melt polycondensation reaction of an aromatic dihydroxy compound and a carbonic acid diester in the presence of a catalyst. In certain embodiments of the present disclosure, polycarbonate can be manufactured from phosgene and a bisphenol by a two-step polycondensation reaction. The polycarbonate polymer in the polycarbonate composition can be generated by an isosorbide melt process, where an aliphatic diol (e.g., isosorbide) reacts with diaryl carbonate.

The one or more catalysts present in the polycarbonate compositions of the disclosed subject matter can include derivatives of alkali metals and alkaline earth metals, such as organic acid salts, inorganic acid salts, oxides, hydroxides, hydrides, alcoholates and combinations thereof. Non-limiting examples of alkali metal compounds that can be used as a catalyst include sodium hydroxide, potassium hydroxide, lithium hydroxide, sodium carbonate, potassium carbonate, lithium carbonate, sodium acetate, potassium acetate, lithium acetate, sodium stearate, potassium stearate and lithium stearate. Examples of alkaline earth metal compounds that can be used as a catalyst include, but are not limited to, calcium hydroxide, barium hydroxide, magnesium hydroxide, strontium hydroxide, calcium hydrogencarbonate, barium hydrogencarbonate, magnesium hydrogencarbonate, strontium hydrogencarbonate, calcium carbonate, barium carbonate, magnesium carbonate, strontium carbonate, calcium acetate, barium acetate, magnesium acetate, strontium acetate, calcium stearate, barium stearate, magnesium stearate and strontium stearate. Additional non-limiting examples of catalysts that can be present in a polycarbonate composition of the presently disclosed subject matter include tetraalkylammonium hydroxide, tetraalkylammonium acetate, tetraalkyl phosphonium hydroxide and tetraalkyl phosphonium acetate.

The polycarbonate composition can further include one or more traditional mold release agents. Traditional mold release agents are single function additives that exhibit release activities. Non-limiting examples of mold release agents include hydrocarbon type release agents such as natural and synthetic paraffins, polyethylene waxes and fluorocarbons, fatty acid type releasants, fatty acid amide type releasants, fatty acid ester type releasants and silicone type releasants such as silicone oils. Additional non-limiting examples of releasants are disclosed in U.S. Pat. Nos. 4,554,302 and 4,119,603, each of which is incorporated herein by reference. In certain embodiments, the mold release agents can include glycerol monostearate, pentaerythritol tetrastearate and combinations thereof. The amount of the mold release agent that can be added to the polycarbonate composition of the presently disclosed matter is an amount which is sufficient to impart the composition with mold releasing properties. The amount of the mold release agent included in a polycarbonate composition of the presently disclosed subject matter depends on various factors, including the grade, purity and formulation of the mold release agent to be used. In certain embodiments, the polycarbonate composition can include one or more release agents in the amount of about 200 ppm to about 800 ppm. For example, but not by way of limitation, the polycarbonate composition can include one or more release agents in the amount of about 200 ppm to about 700 ppm, about 200 ppm to about 600 ppm, about 200 ppm to about 500 ppm, about 200 ppm to about 400 ppm, about 200 ppm to about 300 ppm, about 300 ppm to about 800 ppm, about 400 ppm to about 800 ppm, about 500 ppm to about 800 ppm, about 600 ppm to about 800 ppm or about 700 ppm to about 800 ppm.

In certain embodiments, the polycarbonate composition can include one or more additional components and additives. For example, various function-imparting agents including, but not limited to, heat stabilizers, stabilization adjuvants, plasticizers, antioxidants, photostabilizers, nucleating agents, heavy metal-inactivating agents, flame retardants, lubricants, antistatic agents, colorants and ultraviolet absorbers can be added to the polycarbonate compositions. In certain embodiments, the polycarbonate composition of the presently disclosed subject matter can include fillers, pigments or fibers. Non-limiting examples of fillers include carbon, talc, montmorillonite and hydrotalcite. Non-limiting example of fibers include synthetic fibers, glass fibers, quartz fibers, carbon fibers and natural fibers (e.g., kenaf).

The presently disclosed subject matter further provides a method for generating the disclosed polycarbonate compositions. In certain embodiments, a method of generating a polycarbonate composition of the presently disclosed subject matter can include producing polycarbonate polymers by various polymerization reactions including, but not limited to, melt transesterification of an aromatic dihydroxy compound and a carbonic acid diester, polycondensation of phosgene and a bisphenol and the melt reaction of an aliphatic diol with diaryl carbonate.

For the purpose of illustration and not limitation, FIG. 2 shows a method for generating a polycarbonate composition according to one exemplary embodiment of the disclosed subject matter. As shown in FIG. 2, the method of generating a polycarbonate composition of the presently disclosed subject matter includes introducing a feedstream comprising an aromatic dihydroxy compound and a carbonic acid diester into a reactor to generate one or more polycarbonate polymers in the presence of a catalyst 201 and adding a bi-functional additive agent to the polycarbonate polymers to form a polycarbonate composition 202.

In certain embodiments, the generation of one or more polycarbonate polymers by a melt transesterification reaction can occur in multiple phases. For example, the initial transesterification of an aromatic dihydroxy compound and a carbonic acid diester can be followed by a prepolycondensation and a polycondensation reaction to form polycarbonate polymers of a desired or targeted molecular weight. The method of the presently disclosed subject matter can be performed using any reactor or reactors known to one of ordinary skill in the art. For example, the reactors that can be used in the presently disclosed method include, but are not limited to, transesterification reactors, prepolycondensation reactors and polycondensation reactors.

In certain embodiments, the aromatic dihydroxy compound used in the method of the disclosed subject matter is a bisphenol. Any bisphenol, if suitable as raw material for preparation of polycarbonates, can be used in the presently disclosed method. Non limiting examples of bisphenol include biphenyl-4-4′-diol, 3,5,3′,5′-tetrahydroxybiphenyl, 4,4′-(propane-2,2-diyl)diphenol, bis(4-hydroxyphenyl)methane, 1,2-bis(4-hydroxyphenyl)ethane, 1,1-bis(4-hydroxyphenyl)ethane and 4,4′-(propane-2,2-diyl)diphenol (“bisphenol A”). Additional non-limiting examples of aromatic dihydroxy compounds are described, for example, in U.S. Pat. Nos. 5,126,428, 5,104,723, 5,041,521 and 5,034,457 all of which are incorporated herein by reference. In certain embodiments, the aromatic dihydroxy compound is bisphenol A. In certain embodiments, a combination of one or more aromatic dihydroxy compounds can be used in the method of the disclosed subject matter.

In certain embodiments, the carbonic acid diester can be diphenyl carbonate, a di-(halophenyl)carbonate, such as di-(chlorophenyl)carbonate, di-(bromophenyl)carbonate, di(trichlorophenyl)carbonate and di-(tribromophenyl)carbonate, a di-(alkylphenyl)carbonate, such as di-(tolyl)carbonate, di-(naphthyl)carbonate, di-(chloronaphthyl)carbonate, phenyl tolyl carbonate and chlorophenyl chloro-naphthyl carbonate, and mixtures thereof. Other carbonate precursors can be used in the generation of a polycarbonate composition from aromatic dihydroxy compounds. For example, carbonyl chloride, also known as phosgene, can be used.

As mentioned, the method can further include adding one or more bi-functional additive agents to the polycarbonate polymers to generate a polycarbonate composition 202. Examples of bi-functional additive agents have been previously described herein. The bi-functional additive agent can be added to the polycarbonate polymers at any point during the disclosed method. For example, but not by way of limitation, the one or more bi-functional additive agents can be added to the polycarbonate polymers present in the transesterification reactor. In certain embodiments, the bi-functional additive agent is added to the polycarbonate polymers in an extruder, at the throat of an extruder or during transport of the polycarbonate polymers to an extruder. For example, the incorporation of the bi-functional additive agent into the polycarbonate composition can include tumble blending the bi-functional additive agent with the polycarbonate polymers in an extruder.

In certain embodiments, the method can further include extruding the polycarbonate composition. The polycarbonate composition can be added to form an extrudate. The extrudate can then be collected and subjected to molding using any conventional processes known in the art including, but not limited to, injection molding, blow molding, extrusion molding and thermoforming. The extruder used in the disclosed method can be any extruder known in the art. For example, but not by way of limitation, the extruder can be a vented single screw or double-screw extruder.

In certain embodiments, the method can further include adding one or more traditional mold release agents to the polycarbonate composition. The mold release agents can be added directly to the polycarbonate polymers in combination with a bi-functional additive agent of the present disclosure. Alternatively or additionally, the mold release agent can be added directly to the polycarbonate polymers before or after the addition of the bi-functional additive agent. Non-limiting examples of mold release agents have been previously described herein.

The polycarbonate composition and methods of making disclosed herein include at least the following embodiments:

### Embodiment 1

A polycarbonate composition, comprising: one or more polycarbonate polymers; one or more catalysts; and one or more one bi-functional additive agents; wherein the bi-functional additive agent has quenching and release activities.

### Embodiment 2

The composition of claim 1, wherein the one or more bi-functional additive agents is selected from a carboxylic acid derivative of glycerol monostearate, a sulphonic acid derivative of glycerol monostearate, a carboxylic acid derivative of pentaerythritol tristearate, a sulphonic acid derivative of pentaerythritol tristearate, and combinations thereof.

### Embodiment 3

The composition of claim 1 or claim 2, wherein the one or more polycarbonate polymers is generated from a melt polycondensation reaction of an aromatic dihydroxy compound and a carbonic acid diester in the presence of a catalyst.

### Embodiment 4

The composition of any of claims 1 to 3, wherein the one or more bi-functional additive agents is present in the amount of about 1.0 to about 10.0 parts per million.

### Embodiment 5

The composition of any of claims 1 to 4, wherein the one or more catalysts comprises an alkali metal, an alkaline earth metal, and combinations thereof.

### Embodiment 6

The composition of any of claims 1 to 5, further comprising one or more mold release agents.

### Embodiment 7

The composition of claim 6, wherein the one or more mold release agents is selected from glycerol monostearate, pentaerythritol tetrastearate, and combinations thereof.

### Embodiment 8

The composition of any of claims 1 to 7, further comprising an additive selected from heat stabilizers, stabilization adjuvants, plasticizers, antioxidants, photostabilizers, nucleating agents, heavy metal-inactivating agents, flame retardants, lubricants, antistatic agents, colorants, ultraviolet absorbers, and combinations thereof.

### Embodiment 9

A method for generating a polycarbonate composition, comprising: introducing a feedstream comprising an aromatic dihydroxy compound and carbonic acid diester into a reactor in the presence of one or more catalysts to generate one or more polycarbonate polymers; and adding one or more bi-functional additive agents that has quenching and release activities to the one or more polycarbonate polymers to generate a polycarbonate composition.

### Embodiment 10

The method of claim 9, wherein the aromatic dihydroxy compound is bisphenol-A.

### Embodiment 11

The method of claim 9 or claim 10, wherein the carbonic acid diester is diphenyl carbonate.

### Embodiment 12

The method of any of claims 9 to 11, wherein the one or more bi-functional additive agents is selected from a carboxylic acid derivative of glycerol monostearate, a sulphonic acid derivative of glycerol monostearate, a carboxylic acid derivative of pentaerythritol tristearate, a sulphonic acid derivative of pentaerythritol tristearate, or combinations thereof.

### Embodiment 13

The method of any of claims 9 to 12, wherein the one or more catalysts comprises an alkali metal, an alkaline earth metal, and combinations thereof.

### Embodiment 14

The method of any of claims 9 to 13, wherein the one or more catalysts comprises potassium hydroxide.

### Embodiment 15

The method of any of claims 9 to 14, further comprising transporting the one or more polycarbonate polymers to an extruder to form an extrudate, wherein the one or more bi-functional additive agents is added to the polycarbonate polymers in the extruder.

### Embodiment 16

A method for generating a polycarbonate composition, comprising: producing one or more polycarbonate polymers in the presence of one or more catalysts; and adding one or more bi-functional additive agents that has quenching and release activities to the one or more polycarbonate polymers to generate a polycarbonate composition.

### Embodiment 17

The method of claim 16, wherein the one or more bi-functional additive agents is selected from a carboxylic acid derivative of glycerol monostearate, a sulphonic acid derivative of glycerol monostearate, a carboxylic acid derivative of pentaerythritol tristearate, a sulphonic acid derivative of pentaerythritol tristearate, or combinations thereof.

### Embodiment 18

The method of claim 16 or claim 17, wherein the one or more catalysts comprises an alkali metal, an alkaline earth metal, and combinations thereof.

### Embodiment 19

The method of any of claims 16 to 18, wherein the one or more catalysts comprises potassium hydroxide.

### Embodiment 20

The method of any of claims 16 to 19, wherein the one or more catalysts comprises potassium hydroxide.

In addition to the various embodiments depicted and claimed, the disclosed subject matter is also directed to other embodiments having other combinations of the features disclosed and claimed herein. As such, the particular features presented herein can be combined with each other in other manners within the scope of the disclosed subject matter such that the disclosed subject matter includes any suitable combination of the features disclosed herein. The foregoing description of specific embodiments of the disclosed subject matter has been presented for purposes of illustration and description. It is not intended to be exhaustive or to limit the disclosed subject matter to those embodiments disclosed.

It will be apparent to those skilled in the art that various modifications and variations can be made in the compositions and methods of the disclosed subject matter without departing from the spirit or scope of the disclosed subject matter. Thus, it is intended that the disclosed subject matter include modifications and variations that are within the scope of the appended claims and their equivalents. Various publications, patents and patent applications are cited herein, the contents of which are hereby incorporated by reference in their entireties.

In general, the invention may alternately comprise, consist of, or consist essentially of, any appropriate components herein disclosed. The invention may additionally, or alternatively, be formulated so as to be devoid, or substantially free, of any components, materials, ingredients, adjuvants or species used in the prior art compositions or that are otherwise not necessary to the achievement of the function and/or objectives of the present invention. The endpoints of all ranges directed to the same component or property are inclusive and independently combinable (e.g., ranges of “less than or equal to 25 wt %, or 5 wt % to 20 wt %,” is inclusive of the endpoints and all intermediate values of the ranges of “5 wt % to 25 wt %,” etc.). Disclosure of a narrower range or more specific group in addition to a broader range is not a disclaimer of the broader range or larger group. “Combination” is inclusive of blends, mixtures, alloys, reaction products, and the like. Furthermore, the terms “first,” “second,” and the like, herein do not denote any order, quantity, or importance, but rather are used to denote one element from another. The terms “a” and “an” and “the” herein do not denote a limitation of quantity, and are to be construed to cover both the singular and the plural, unless otherwise indicated herein or clearly contradicted by context. “Or” means “and/or.” The suffix “(s)” as used herein is intended to include both the singular and the plural of the term that it modifies, thereby including one or more of that term (e.g., the film(s) includes one or more films). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

The modifier “about” used in connection with a quantity is inclusive of the stated value and has the meaning dictated by the context (e.g., includes the degree of error associated with measurement of the particular quantity). The notation “+10%” means that the indicated measurement can be from an amount that is minus 10% to an amount that is plus 10% of the stated value. The terms “front”, “back”, “bottom”, and/or “top” are used herein, unless otherwise noted, merely for convenience of description, and are not limited to any one position or spatial orientation. “Optional” or “optionally” means that the subsequently described event or circumstance can or cannot occur, and that the description includes instances where the event occurs and instances where it does not. Unless defined otherwise, technical and scientific terms used herein have the same meaning as is commonly understood by one of skill in the art to which this invention belongs. A “combination” is inclusive of blends, mixtures, alloys, reaction products, and the like.

As used herein, the term “hydrocarbyl” and “hydrocarbon” refers broadly to a substituent comprising carbon and hydrogen, optionally with 1 to 3 heteroatoms, for example, oxygen, nitrogen, halogen, silicon, sulfur, or a combination thereof; “alkyl” refers to a straight or branched chain, saturated monovalent hydrocarbon group; “alkylene” refers to a straight or branched chain, saturated, divalent hydrocarbon group; “alkylidene” refers to a straight or branched chain, saturated divalent hydrocarbon group, with both valences on a single common carbon atom; “alkenyl” refers to a straight or branched chain monovalent hydrocarbon group having at least two carbons joined by a carbon-carbon double bond; “cycloalkyl” refers to a non-aromatic monovalent monocyclic or multicylic hydrocarbon group having at least three carbon atoms, “cycloalkenyl” refers to a non-aromatic cyclic divalent hydrocarbon group having at least three carbon atoms, with at least one degree of unsaturation; “aryl” refers to an aromatic monovalent group containing only carbon in the aromatic ring or rings; “arylene” refers to an aromatic divalent group containing only carbon in the aromatic ring or rings; “alkylaryl” refers to an aryl group that has been substituted with an alkyl group as defined above, with 4-methylphenyl being an exemplary alkylaryl group; “arylalkyl” refers to an alkyl group that has been substituted with an aryl group as defined above, with benzyl being an exemplary arylalkyl group; “acyl” refers to an alkyl group as defined above with the indicated number of carbon atoms attached through a carbonyl carbon bridge (—C(═O)—); “alkoxy” refers to an alkyl group as defined above with the indicated number of carbon atoms attached through an oxygen bridge (—O—); and “aryloxy” refers to an aryl group as defined above with the indicated number of carbon atoms attached through an oxygen bridge (—O—).

Unless otherwise indicated, each of the foregoing groups can be unsubstituted or substituted, provided that the substitution does not significantly adversely affect synthesis, stability, or use of the compound. The term “substituted” as used herein means that at least one hydrogen on the designated atom or group is replaced with another group, provided that the designated atom's normal valence is not exceeded. When the substituent is oxo (i.e., ═O), then two hydrogens on the atom are replaced. Combinations of substituents and/or variables are permissible provided that the substitutions do not significantly adversely affect synthesis or use of the compound. Exemplary groups that can be present on a “substituted” position include, but are not limited to, cyano; hydroxyl; nitro; azido; alkanoyl (such as a C₂₋₆ alkanoyl group such as acyl); carboxamido; C₁₋₆ or C₁₋₃ alkyl, cycloalkyl, alkenyl, and alkynyl (including groups having at least one unsaturated linkages and from 2 to 8, or 2 to 6 carbon atoms); C₁₋₆ or C₁₋₃ alkoxys; C₆₋₁₀ aryloxy such as phenoxy; C₁₋₆ alkylthio; C₁₋₆ or C₁₋₃ alkylsulfinyl; C1-6 or C₁₋₃ alkylsulfonyl; aminodi(C₁₋₆ or C₁₋₃)alkyl; C₆₋₁₂ aryl having at least one aromatic rings (e.g., phenyl, biphenyl, naphthyl, or the like, each ring either substituted or unsubstituted aromatic); C₇₋₁₉ arylalkyl having 1 to 3 separate or fused rings and from 6 to 18 ring carbon atoms; or arylalkoxy having 1 to 3 separate or fused rings and from 6 to 18 ring carbon atoms, with benzyloxy being an exemplary arylalkoxy.

All cited patents, patent applications, and other references are incorporated herein by reference in their entirety. However, if a term in the present application contradicts or conflicts with a term in the incorporated reference, the term from the present application takes precedence over the conflicting term from the incorporated reference

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A polycarbonate composition, comprising:
one or more polycarbonate polymers;
one or more catalysts; and
one or more one bi-functional additive agents;
wherein the bi-functional additive agent has quenching and release activities.

2. The composition of claim 1, wherein the one or more bi-functional additive agents is selected from a carboxylic acid derivative of glycerol monostearate, a sulphonic acid derivative of glycerol monostearate, a carboxylic acid derivative of pentaerythritol tristearate, a sulphonic acid derivative of pentaerythritol tristearate, and combinations thereof.

3. The composition of claim 1, wherein the one or more polycarbonate polymers is generated from a melt polycondensation reaction of an aromatic dihydroxy compound and a carbonic acid diester in the presence of a catalyst.

4. The composition of claim 1, wherein the one or more bi-functional additive agents is present in the amount of about 1.0 to about 10.0 parts per million.

5. The composition of claim 1, wherein the one or more catalysts comprises an alkali metal, an alkaline earth metal, and combinations thereof.

6. The composition of claim 1, further comprising one or more mold release agents.

7. The composition of claim 6, wherein the one or more mold release agents is selected from glycerol monostearate, pentaerythritol tetrastearate, and combinations thereof.

8. The composition of claim 1, further comprising an additive selected from heat stabilizers, stabilization adjuvants, plasticizers, antioxidants, photostabilizers, nucleating agents, heavy metal-inactivating agents, flame retardants, lubricants, antistatic agents, colorants, ultraviolet absorbers, and combinations thereof.

9. A method for generating a polycarbonate composition, comprising:
introducing a feedstream comprising an aromatic dihydroxy compound and carbonic acid diester into a reactor in the presence of one or more catalysts to generate one or more polycarbonate polymers; and
adding one or more bi-functional additive agents that has quenching and release activities to the one or more polycarbonate polymers to generate a polycarbonate composition.

10. The method of claim 9, wherein the aromatic dihydroxy compound is bisphenol-A.

11. The method of claim 9, wherein the carbonic acid diester is diphenyl carbonate.

12. The method of claim 9, wherein the one or more bi-functional additive agents is selected from a carboxylic acid derivative of glycerol monostearate, a sulphonic acid derivative of glycerol monostearate, a carboxylic acid derivative of pentaerythritol tristearate, a sulphonic acid derivative of pentaerythritol tristearate, or combinations thereof.

13. The method of claim 9, wherein the one or more catalysts comprises an alkali metal, an alkaline earth metal, and combinations thereof.

14. The method of claim 9, wherein the one or more catalysts comprises potassium hydroxide.

15. The method of claim 9, further comprising transporting the one or more polycarbonate polymers to an extruder to form an extrudate, wherein the one or more bi-functional additive agents is added to the polycarbonate polymers in the extruder.

16. A method for generating a polycarbonate composition, comprising:
producing one or more polycarbonate polymers in the presence of one or more catalysts; and
adding one or more bi-functional additive agents that has quenching and release activities to the one or more polycarbonate polymers to generate a polycarbonate composition.

17. The method of claim 16, wherein the one or more bi-functional additive agents is selected from a carboxylic acid derivative of glycerol monostearate, a sulphonic acid derivative of glycerol monostearate, a carboxylic acid derivative of pentaerythritol tristearate, a sulphonic acid derivative of pentaerythritol tristearate, or combinations thereof.

18. The method of claim 16, wherein the one or more catalysts comprises an alkali metal, an alkaline earth metal, and combinations thereof.

19. The method of claim 16, wherein the one or more catalysts comprises potassium hydroxide.

20. The method of any claim 16, wherein the one or more catalysts comprises potassium hydroxide.
